(19) United States
(12) Patent Application Publication
(10) Pub. No.: US 2025/0060482 A1
(43) Pub. Date: Feb. 20, 2025

(54) LIDAR Detection System

(71) Applicant: The Indoor Lab, LLC, San Juan Capistrano, CA (US)

(72) Inventor: Patrick Blattner, Dana Point, CA (US)

(73) Assignee: The Indoor Lab, LLC, San Juan Capistrano, CA (US)

(21) Appl. No.: 18/619,531

(22) Filed: Mar. 28, 2024

Related U.S. Application Data
(60) Provisional application No. 63/456,084, filed on Mar. 31, 2023.

(51) Int. Cl. G01S 17/89; B60L 13/04; B61B 13/08

(52) U.S. Cl. CPC G01S 17/89; B60L 13/04; B61B 13/08; B61L 2210/04

(57) ABSTRACT

A monitoring system having a track; a cart carrying at least one monitoring device and a power supply; and a propulsion system for moving the cart along the track. the monitoring system scanning an area alongside the track.

### CROSS-REFERENCE TO RELATED APPLICATIONS

This application claims priority to provisional application No. 63/456,084, filed Mar. 31, 2023, the entire contents of which are incorporated by reference.

### BACKGROUND OF THE INVENTION

Airports are busy places with numerous planes taking off and landing every day. One of the biggest safety concerns at airports is debris on the ground, which can cause serious damage to aircraft and endanger passengers. Traditional methods of debris detection and removal can be time-consuming and unreliable, leading to potential safety risks. However, by using LiDAR sensors with perception software and artificial intelligence, airports can improve their safety measures and create a safer environment for everyone. This application will explore how this technology can be used to detect debris on the ground at airports.

### SUMMARY OF THE INVENTION

LiDAR (Light Detection and Ranging) is a remote sensing technology that uses laser beams to create a 3D map of the surrounding environment. LiDAR sensors emit laser beams that bounce off objects and return to the sensor, allowing it to calculate the distance and shape of the object. Perception software and machine learning algorithms can enhance the capabilities of LiDAR technology by enabling it to recognize and classify different objects and movements.

LiDAR sensors with perception software and artificial intelligence can be used to detect debris on airfields. By scanning the ground, LiDAR sensors can detect even small debris such as screws, bolts, and other metal objects that can pose a danger to aircraft. Perception software can then analyze the data from the LiDAR sensor and identify potential hazards. Artificial intelligence can be used to create an algorithm that can recognize the characteristics of debris and distinguish them from other objects such as leaves, rocks, and other harmless items.

One embodiment could have two LiDAR's, one on each side of the runway, and each mounted on a Maglev system. The LiDAR's could move down and back along the runway, either synchronized or independently, scanning the runway from each side for debris. Another embodiment could use just one LiDAR on one side of the runway to scan the entire width of the runway.

Using LiDAR sensors with perception software and artificial intelligence for debris detection at airports has several benefits. First, it is a fast and reliable way to detect debris, which can improve the safety of airfields. Second, it reduces the need for manual inspections, which can be time-consuming and potentially dangerous for staff. Third, it allows for better tracking of debris on airfields, which can help airport staff to identify the sources of debris and take measures to prevent future occurrences.

LiDAR technology with perception software and artificial intelligence has the potential to revolutionize debris detection on airfields. By providing a fast, reliable, and efficient way to detect debris, airports can improve their safety measures and create a safer environment for everyone. While there are still some challenges that need to be addressed, such as the cost of implementing this technology and the need for trained personnel to operate it, the potential benefits of this technology are significant and far-reaching.

A monitoring system having a track; a cart carrying at least one monitoring device and a power supply; and a propulsion system for moving the cart along the track, the monitoring system scanning an area alongside the track.

Any type of propulsion system can be used, but the preferred embodiment uses a magnetic propulsion system, and is configured to allow the cart to move forwards and backwards along the track.

The monitoring device is preferably a LIDAR device, and even more preferably three LIDAR's arranged to cover 180 degrees alongside the track.

The magnetic propulsion system is further comprised of permanent magnets positioned underneath the cart and a plurality of stator sections extending along the track, each sequentially powered by a power system as the cart moves over them. The power system is a drive cabinet arranged alongside the track, each drive cabinet powering multiple stator sections, for example 36 stator sections per drive cabinet. The stator sections can be configured to either push or pull the cart, so the cart can move in both directions along the track. Each stator section is only powered when the cart is above it, so that as the cart approaches the next stator section, it is energized to provide magnetic propulsion and the preceding stator section is de-energized to save on power consumption. Magnetic braking sections can be arranged at either end of the track to gradually slow the cart down. The cart can also include on board batteries and an alternator to power all the electrical devices carried by the cart. The on board batteries can also be re-generatively charged by the magnetic braking sections to extend battery power.

The inventive monitoring system can be used for monitoring an airport runway and detecting debris on the runway. The debris is detected by comparing the LIDAR scan of the runway to a reference scan, so that by subtracting the reference image from the most recent scan, the debris will be readily identifiable, down to 2 cm.

The monitoring system can be used for monitoring a section of border of a country. The cart includes a GPS and a wireless communication system and the LIDAR detects people and reports their GPS coordinates along with the date and time to the authorities using the wireless communication system. The wireless communication system can be any available system such as cellular, wifi or bluetooth. The track can be elevated at least 20 feet above the ground, and preferably 60 feet above the ground.

The monitoring system can be used for monitoring a runway on an aircraft carrier, a race track, such as a Formula 1 track, a Nascar track or a Moto track.

The monitoring system can be used for monitoring a pipeline.

The monitoring system can be used for monitoring a bridge, such as any long span bridge.

### BRIEF DESCRIPTION OF DRAWINGS

FIG. 1 shows the LIDAR monitoring system.

FIG. 2 shows the track, a stator section and the cart.

FIG. 3 shows the cart in more detail.

FIG. 4 shows the track, stator and cart assembled.

FIG. 5 shows the track inside an enclosure.

FIG. 6 shows a photo of a section of track.

FIG. 7 shows a wheel assembly.

FIG. 8 shows the cart plates carrying the permanent magnet positioned next to the stator plate.

FIG. 9 shows the track with three stator sections.

FIG. 10 shows several applications for the LIDAR detection system.

FIG. 11 shows the invention positioned next to a runway.

FIG. 12 shows an example monitoring display for a runway.

FIG. 13 shows an example of a plot of debris detected over time.

FIG. 14 shows an example of a grid alert display, which is configured to allow precise location of debris on a grid, and the size of the debris.

FIG. 15 shows several additional applications for the LIDAR detection system.

FIG. 16 shows the invention deployed on an aircraft carrier.

FIG. 17 shows the invention deployed on a Nascar racetrack.

FIG. 18 shows a racetrack with three carts carrying LIDAR detecting devices deployed.

FIG. 19 shows another racetrack with a track carrying at least one LIDAR detecting device for foreign object detection.

FIG. 20 shows advertising carried by the LIDAR detection device.

FIG. 21 shows the invention deployed for long span bridge inspection.

FIG. 22 shows the invention deployed for pipeline inspection.

FIG. 23 shows the invention deployed along a country border.

### DETAILED DESCRIPTION OF THE INVENTION

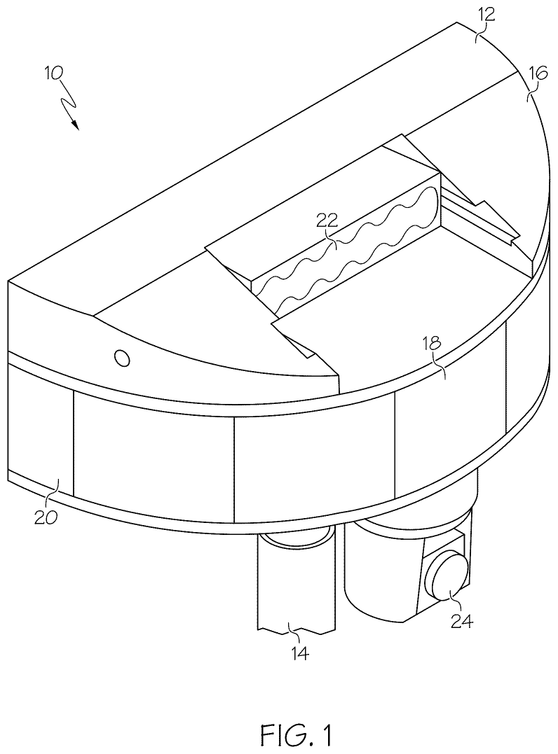

FIG. 1 shows the LIDAR monitoring system, shown generally at 10, including the enclosure 12, carried by pole 14. The enclosure carries three LIDAR devices, 16, 18 and 20, which provide a 3D map covering 180 degrees around the enclosure 12. An HD light 22 is provided in case of darkness, and an HD camera 24 is provided to supplement the 3D lidar map. An optional GPS unit can also be carried, if GPS location coordinates are desirable. A wireless communication device can also be included to allow transmission of the scan data and GPS data to the authorities. The wireless communication system can be any available system such as cellular, wifi or bluetooth.

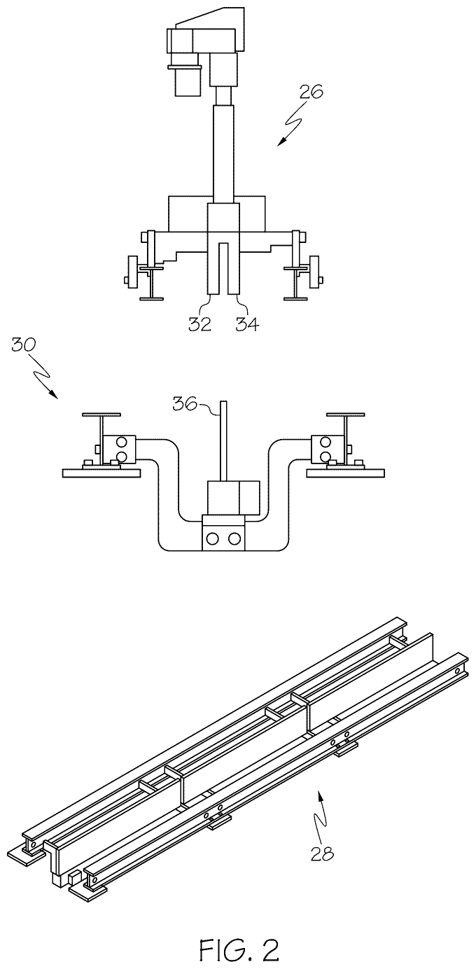

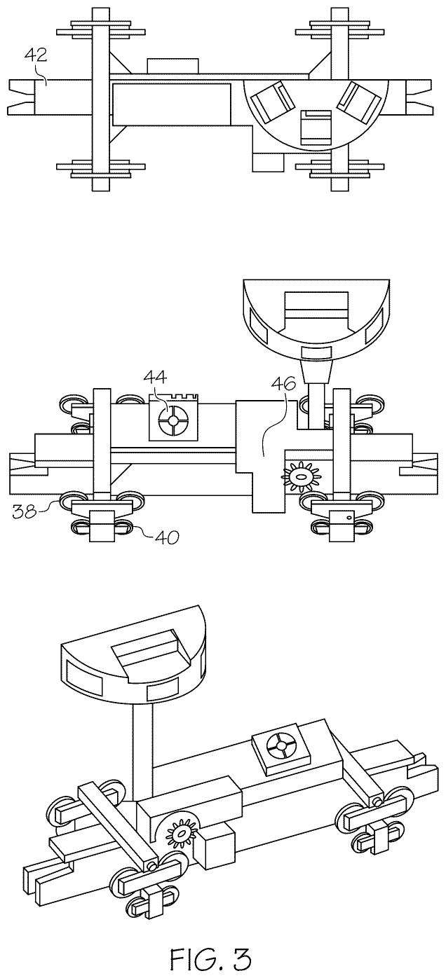

FIG. 2 shows the cart generally at 26, the track, generally at 28, and a stator section, shown generally at 30. The cart 26, has plates 32 and 34, which fit around stator plate 36, which carry coils when energized produce a magnetic field which interact with the plates 32 and 34 which carry a permanent magnet, to either push or pull the cart, causing it to move down the track. Each stator section 30 is powered by power cables that come from a drive cabinet (not shown). As each stator section 30 is energized the electromagnetic wave form drives the cart along the track in a frictionless manner. The cart has wheels (upper wheels 38 and lower wheels 40, best shown in FIG. 3) and still rolls along the track, however; the cart is being pushed or pulled by the magnetic wave form emitting from the stator sections 30.

FIG. 3 shows the cart 26 in more detail. The cart has a platform 42 which carry two sets of wheels, front and back, the wheels having top and bottom wheels 38 and 40. The cart carries a computer 44 and a battery 46, which powers the computer and LIDAR equipment.

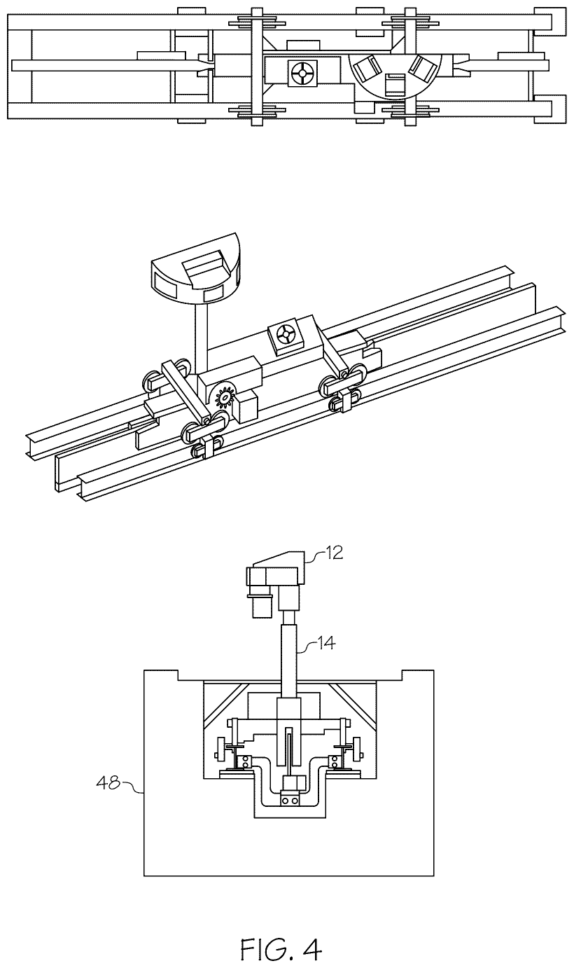

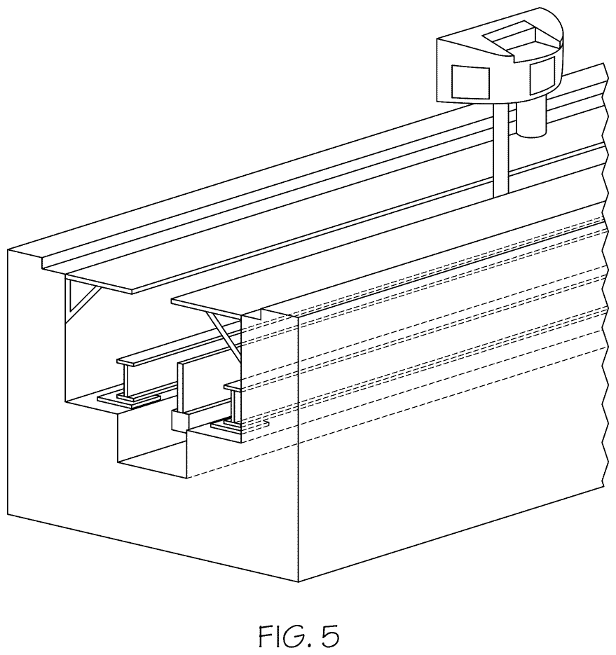

FIG. 4 shows the track 28, with the stator 30, carrying the cart 26, inside the enclosure 48, which has an opening through which pole 14 and LIDAR enclosure 12 extend. FIG. 5 shows a perspective view of FIG. 4.

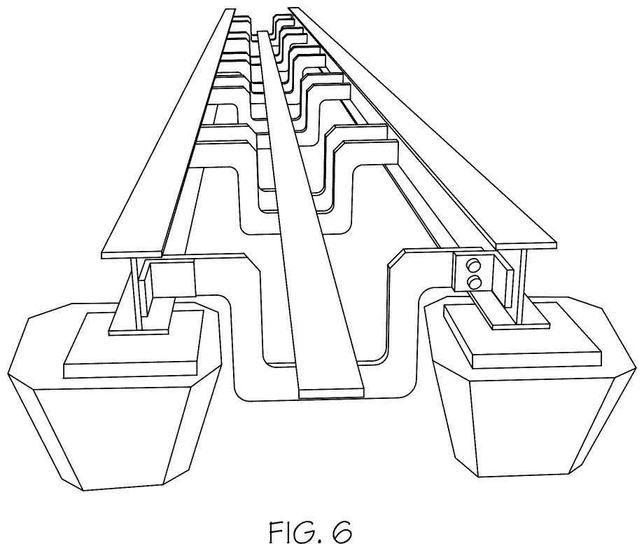

FIG. 6 shows a picture of a section of track 28.

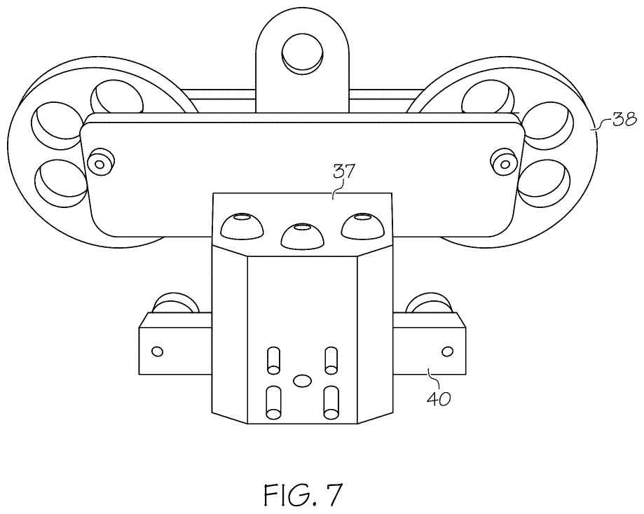

FIG. 7 shows a wheel assembly 37, including the top wheels 38 and the lower wheels 40.

FIG. 8 shows the cart 26 on the stator section 30, with cart plates 32 and 34, which carry permanent magnet 50, which is positioned close to stator plate 36.

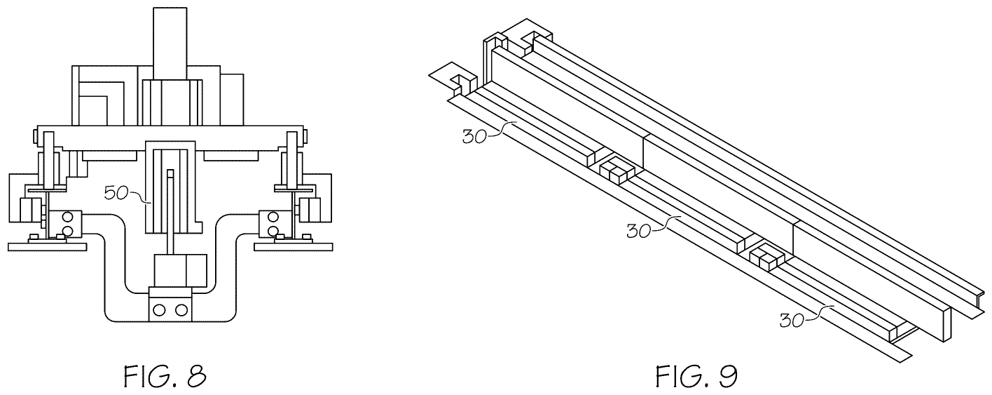

FIG. 9 shows the track with three stator sections 30. As the cart 26 passes over each stator section 30, the stator section is energized to generate the magnetic field which either pushes or pulls the cart, causing it to move down the track. The cart can move in either direction and can be speed up or slowed down by controlling the magnetic field generated by the stator section 30. The track can be as long as desired, carrying as many stator sections as necessary. A drive cabinet (not shown) provides power for up to 36 stator sections, and as many drive cabinets are provided as is necessary. Each stator section 30 is energized as the cart 26 passes over it, and de-energized after the cart has passed over it to minimize the power necessary to move the cart. The drive cabinets can obtain their power from solar power, generators or direct AC hookup, depending on location.

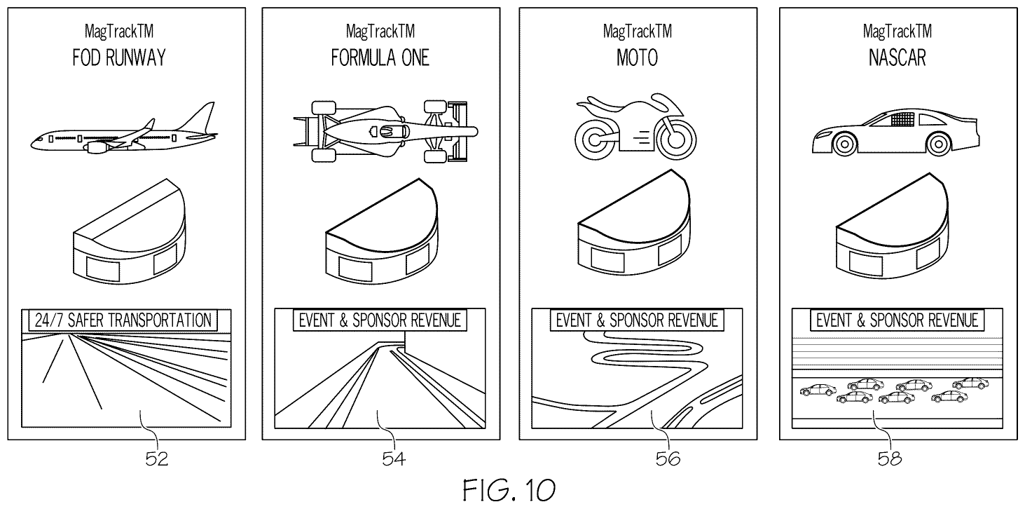

FIG. 10 shows several applications for the LIDAR detection system. These applications show the LIDAR detection system used for foreign object detection (FOD) for a runway (52), on a Formula One track (54), on a MOTO track (56) and on a Nascar track (58). The track is positioned next to the track and a reference LIDAR scan is compared to a current scan, which allows for any foreign object (down to 2 centimeters in size) to be detected. The scan can be performed before a take-off or landing or before each race or after an accident on the track. Detecting foreign objects and facilitating their removal improves the safety of airports and race tracks.

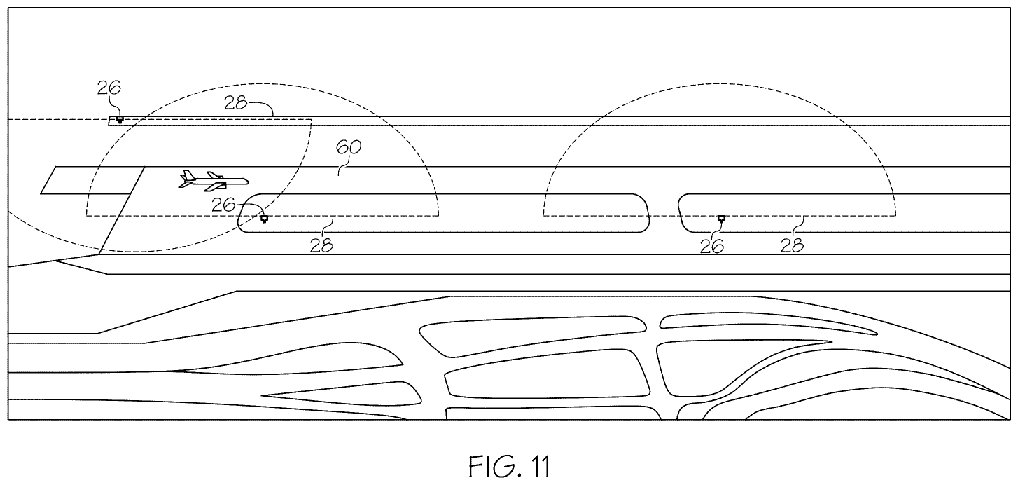

FIG. 11 shows a runway 60 with several tracks 28 and carts 26 positioned on either side of the runway. The invention can image the entire runway from one side, but provides better detection if positioned on both sides.

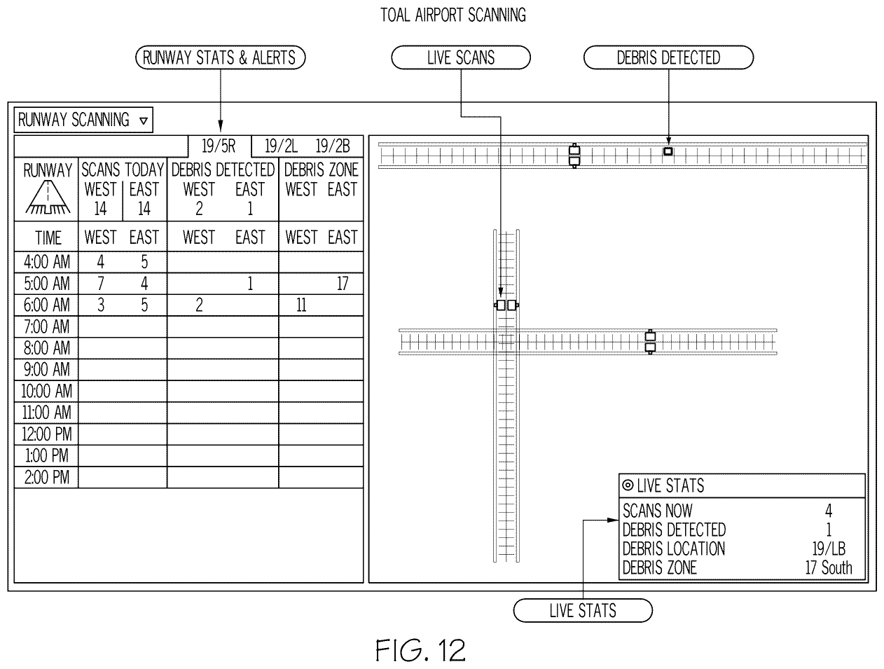

FIG. 12 shows an example runway monitoring display for a runway foreign object detection (FOB) system.

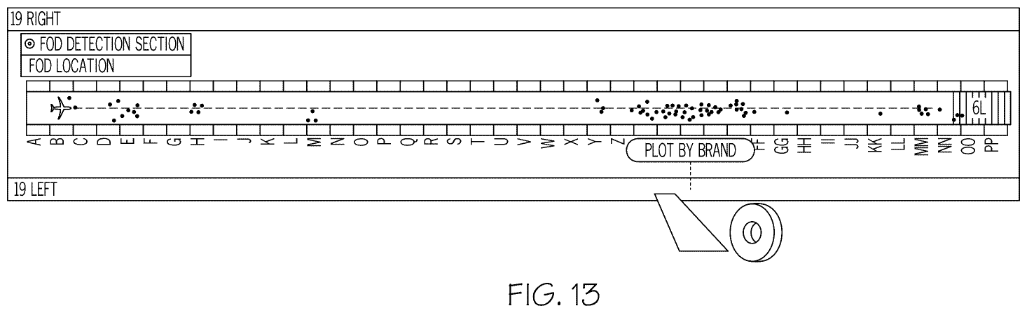

FIG. 13 shows a display which shows debris detection over time, which allows for identifying critical points, such as areas where debris blows onto the runway or areas where birds cluster.

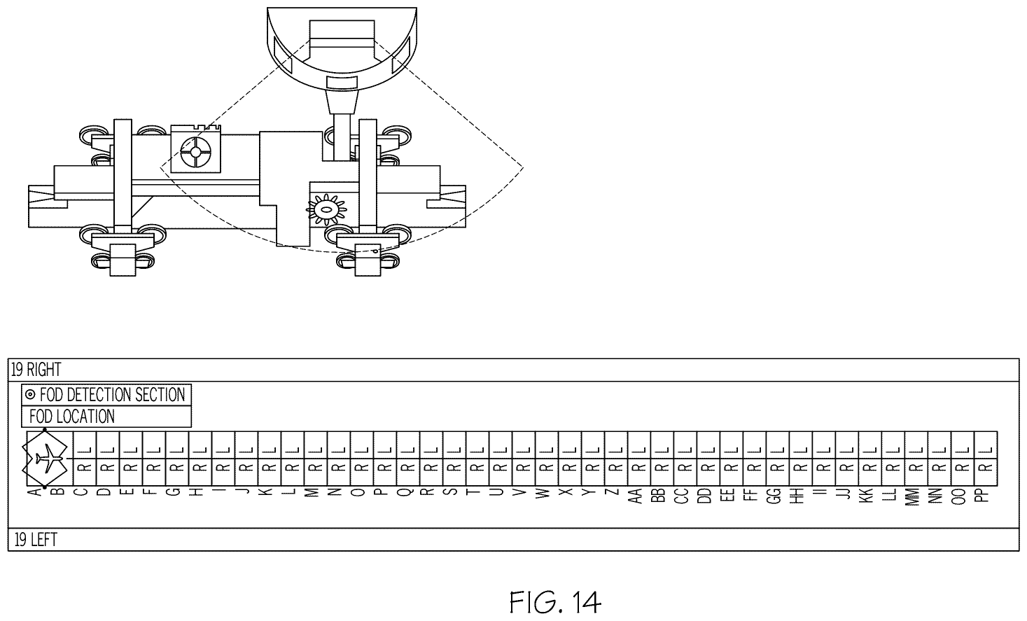

FIG. 14 shows an example of a grid alert display, which is configured to allow precise location of debris on a grid, and the size of the debris. The cart can be requested to move to the grid location and turn on a light to allow for a user to know where the debris is, for ease of removal.

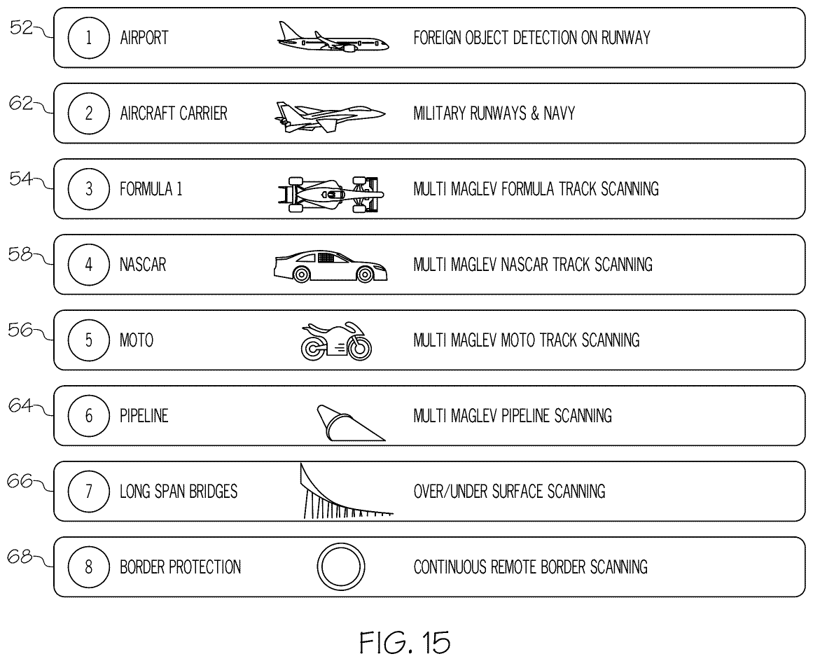

FIG. 15 shows several additional applications for the LIDAR detection system. In addition to the four application shown in FIG. 10, the LIDAR detection system can be used for foreign object detection (FOD) for a runway on an aircraft carrier (62), for pipeline scanning (64), for over/under long span bridge scanning (66) and for border protection (68).

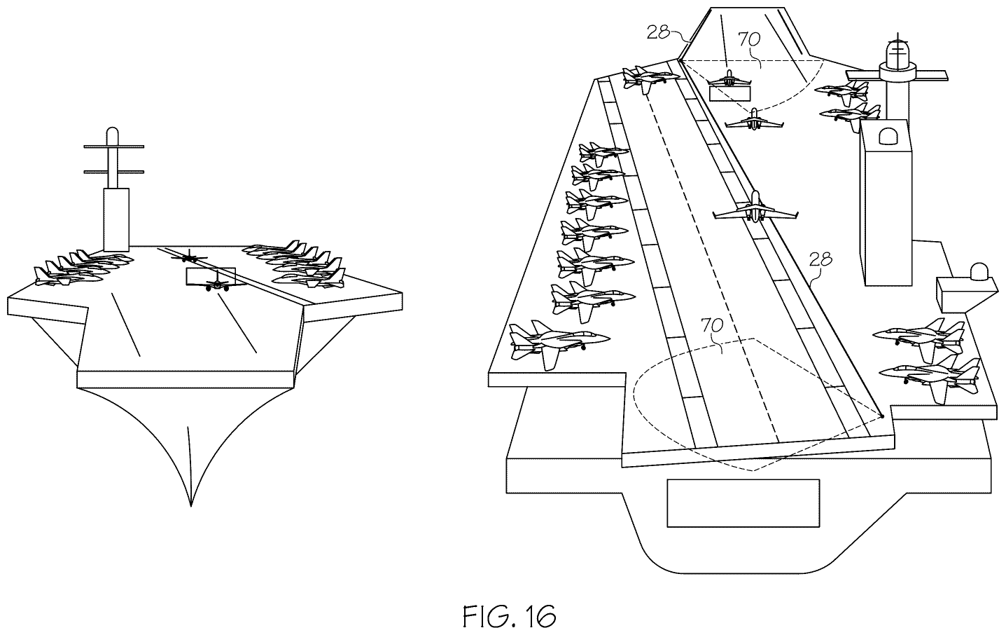

FIG. 16 shows the invention deployed on an aircraft carrier, where the track is shown at 28 and the LIDAR scanning coverage is shown at 70.

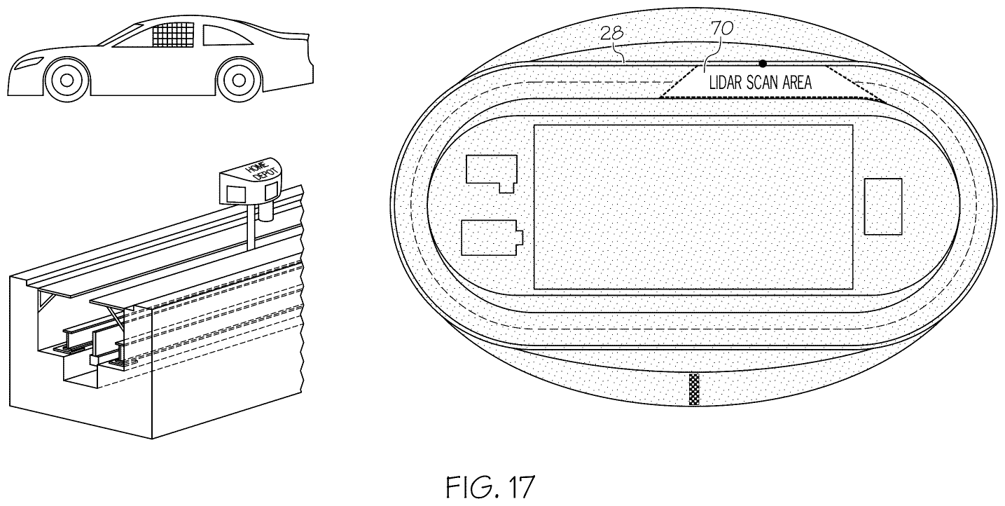

FIG. 17 shows the invention deployed on a Nascar racetrack, where the track is shown at 28 and the LIDAR scanning coverage is shown at 70.

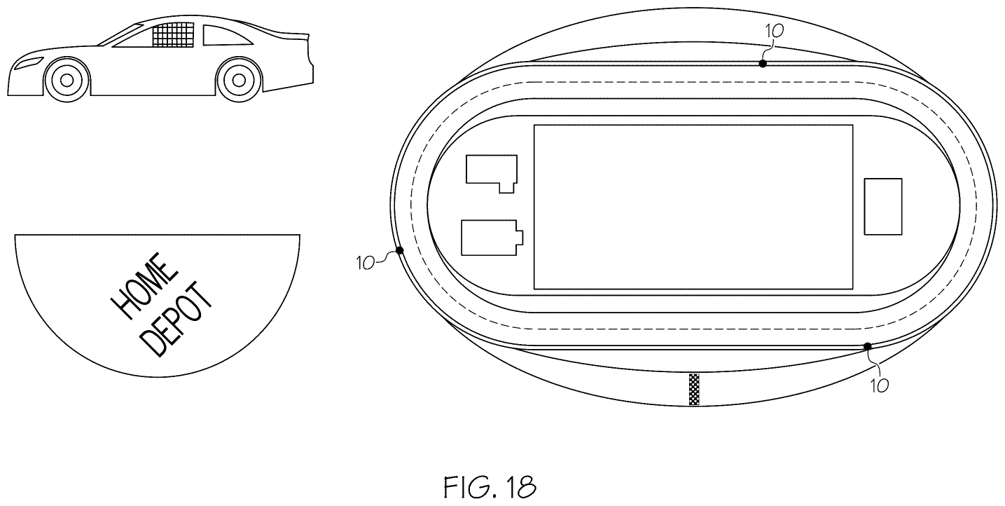

FIG. 18 shows that multiple LIDAR detection devices 10 can be deployed. Advertising opportunities also exist with this technology.

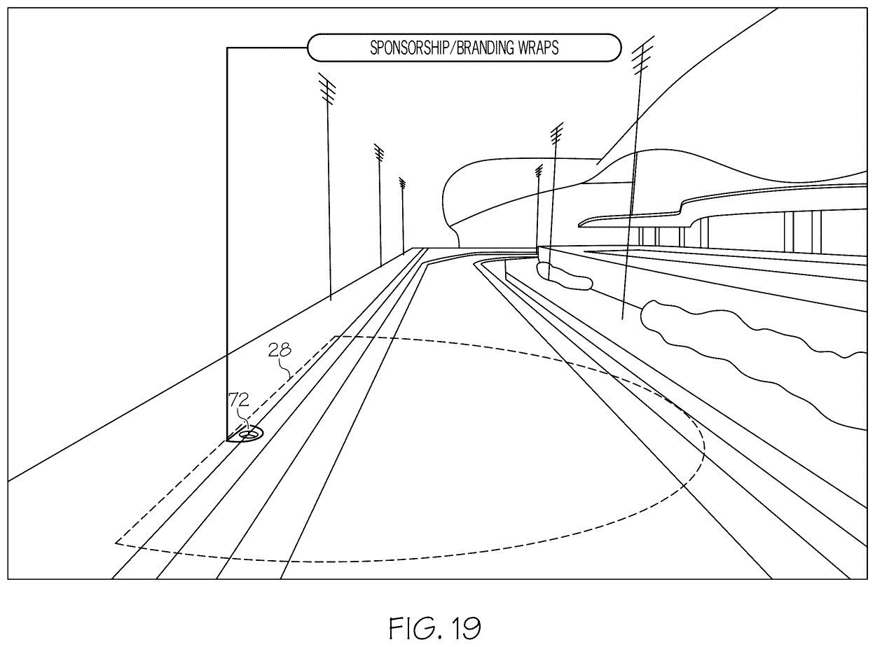

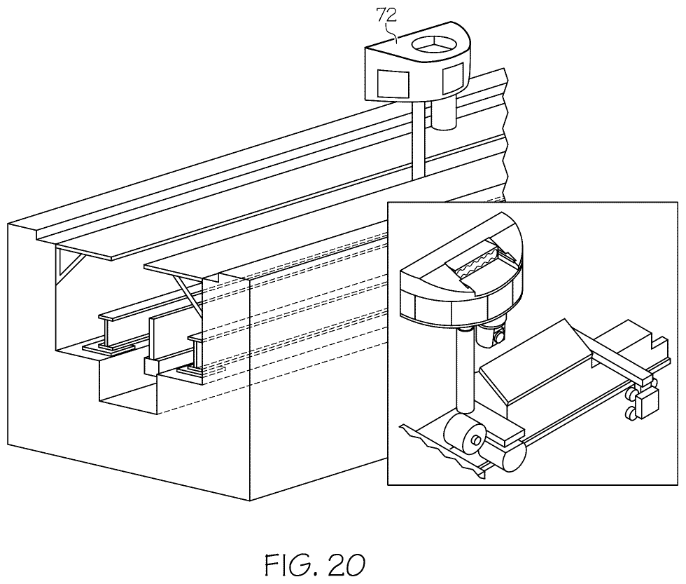

FIGS. 19 and 20 show a track 28 deployed at a Formula One track with advertising 72 shown on top of the enclosure 12. Multiple carts 26 can be deployed if desired.

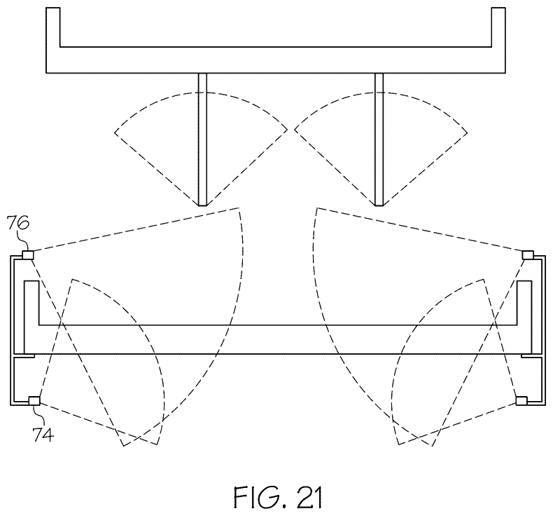

FIG. 21 shows the invention deployed for long span bridge inspection, with LIDAR devices positioned for scanning under and over the bridge, at 74 and 76.

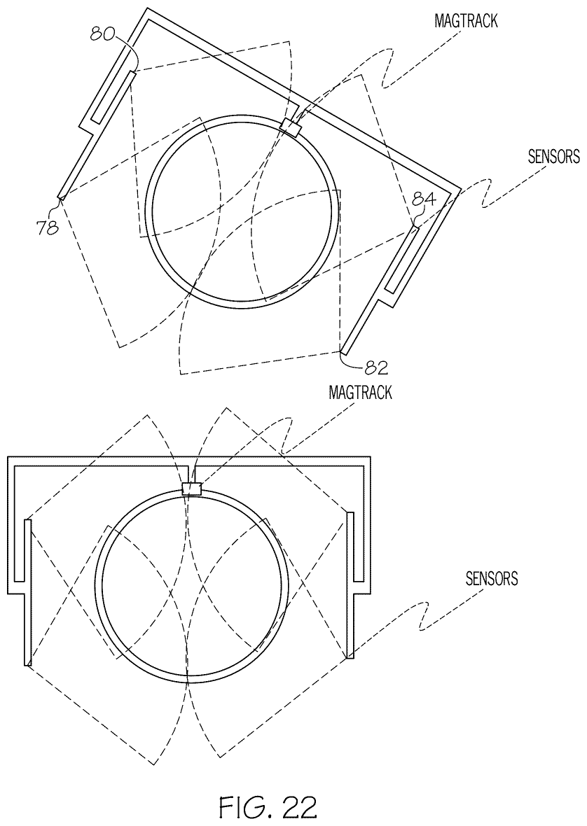

FIG. 22 shows the invention deployed for pipeline inspection, with multiple LIDARS shown at 78, 80, 82 and 84 for scanning around the entire pipeline.

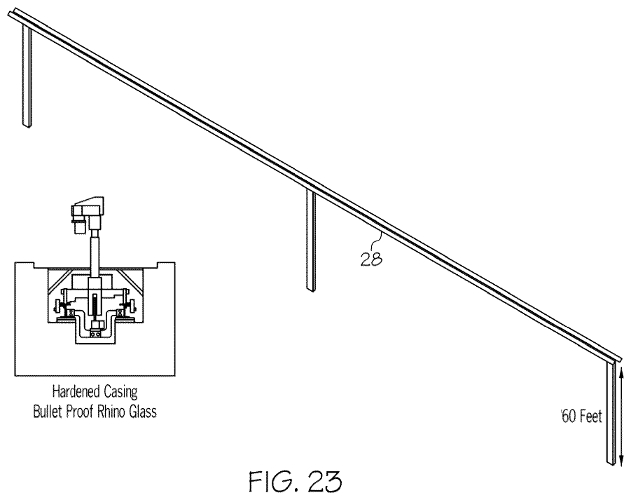

FIG. 23 shows the invention deployed along a country border to scan for border crossings. The track 28 can be elevated, 60 feet in this instance, to prevent the detection device from being tampered with. The scan data can be wirelessly transmitted to authorities along with geo location data.

1. A monitoring system comprising:
a track;
a cart carrying at least one monitoring device and a power supply;
a propulsion system for moving the cart along the track;
the monitoring system scanning an area alongside the track.

2. The monitoring system of claim 1 wherein the propulsion system is constructed and arranged to allow the cart to move forwards and backwards along the track.

3. The monitoring system of claim 1 wherein the propulsion system is magnetic.

4. The monitoring system of claim 1 wherein the at least one monitoring device is a LIDAR.

5. The monitoring system of claim 3 wherein the magnetic propulsion system is further comprised of permanent magnets positioned underneath the cart and a plurality of stator sections extending along the track, each sequentially powered by a power system as the cart moves over them.

6. The monitoring system of claim 4 for monitoring an airport runway and detecting debris on the runway.

7. The monitoring system of claim 5 wherein the debris is detected by comparing the LIDAR scan of the runway to a reference scan.

8. The monitoring system of claim 4 for monitoring a section of border of a country.

9. The monitoring system of claim 8 wherein the cart includes a GPS and a wireless communication system and the LIDAR detects people and reports their GPS coordinates along with the date and time to the authorities using the wireless communication system.

10. The monitoring system of claim 8 wherein the wireless communication system is selected from the group consisting of cellular, wifi and bluetooth.

11. The monitoring system of claim 8 wherein the track is elevated at least 20 feet above the ground.

12. The monitoring system of claim 1 for monitoring a runway on an aircraft carrier.

13. The monitoring system of claim 1 for monitoring a race track.

14. The monitoring system of claim 13 wherein the race track is selected from the group consisting of formula 1, nascar and moto.

15. The monitoring system of claim 1 for monitoring a pipeline.

16. The monitoring system of claim 1 for monitoring a bridge.
